(19) United States
(12) Patent Application Publication
(10) Pub. No.: US 2013/0066704 A1
(43) Pub. Date: Mar. 14, 2013

(54) SHOPPING SYSTEM AND METHOD OF PROVIDING SAVINGS USING THE SAME

(71) Applicant: Abdul Raheeda Hodge, Coral Springs, FL (US)

(72) Inventor: Abdul Raheeda Hodge, Coral Springs, FL (US)

(21) Appl. No.: 13/232,098

(22) Filed: Sep. 14, 2011

(51) Int. Cl. G06Q 30/00

(52) U.S. Cl. 705/14.39

(57) ABSTRACT

A savings system that utilizes a website on a server having an administrator that is implemented over an electronic network. The website has software that is able to electrically communicate with a plurality of consumers, product and service provider databases, and product manufacturer databases. Each of the plurality of consumers receive a card that provides consumer information to a database that is communicated to the website and based on the activity of the plurality of consumers or team of consumers savings and discounts are provided to an account.

### BACKGROUND OF THE INVENTION

This invention relates to a shopping system. More specifically, this invention relates to a method of using the shopping system wherein a plurality of consumers act as a team to receive savings.

Many friends and family members share similar interests in shopping. Oftentimes close friends and family members knowingly or even unknowingly shop at the same stores and purchase the same brand items. Specifically, people tend to be socially connected with individuals of similar interests and values.

In addition, millions of dollars of savings are lost each year due to people simply throwing away coupons. Those savings are provided by companies in an attempt to get purchasers to buy their products. Thus, retail stores and manufacturers need to find a more effective way of focusing their rewards and savings towards individuals who consistently purchase their product.

Thus, a need in the art exists for a manner in which individuals that share common interests and purchase similar items can use their common interests to provide savings. A further need in the art; exists for a way for manufacturers and retail stores to find and focus in on such consumers in order to provide savings that encourages a consumer to go to their store or buy their products.

Thus, a principal object of the present invention is to provide a savings system and method of providing savings that presents a website that has software that allows a plurality of consumers to act as a team to generate savings.

Yet another object of the present invention is to provide a savings system and method of providing a savings that will focus retail and manufactures savings productively.

These and other objects, features, and advantages will become apparent from the specification and claims.

### BRIEF SUMMARY OF THE INVENTION

A method of providing savings that includes providing a website on a server having an administrator where the website has associated software that determines savings. Next, the software generates an account that has a plurality of consumers associated with the account. Purchasing information is then electrically communicated via an electronic network from the plurality of consumers associated with the account to the website from a remote location such as a retail store when purchases are being made. The software then calculates and provides savings in the account that is received by each of plurality of consumers.

### BRIEF DESCRIPTION OF THE DRAWINGS

FIG. 1 is a schematic diagram of a shopping system;

FIG. 2 is a flow diagram of a method of providing savings; and

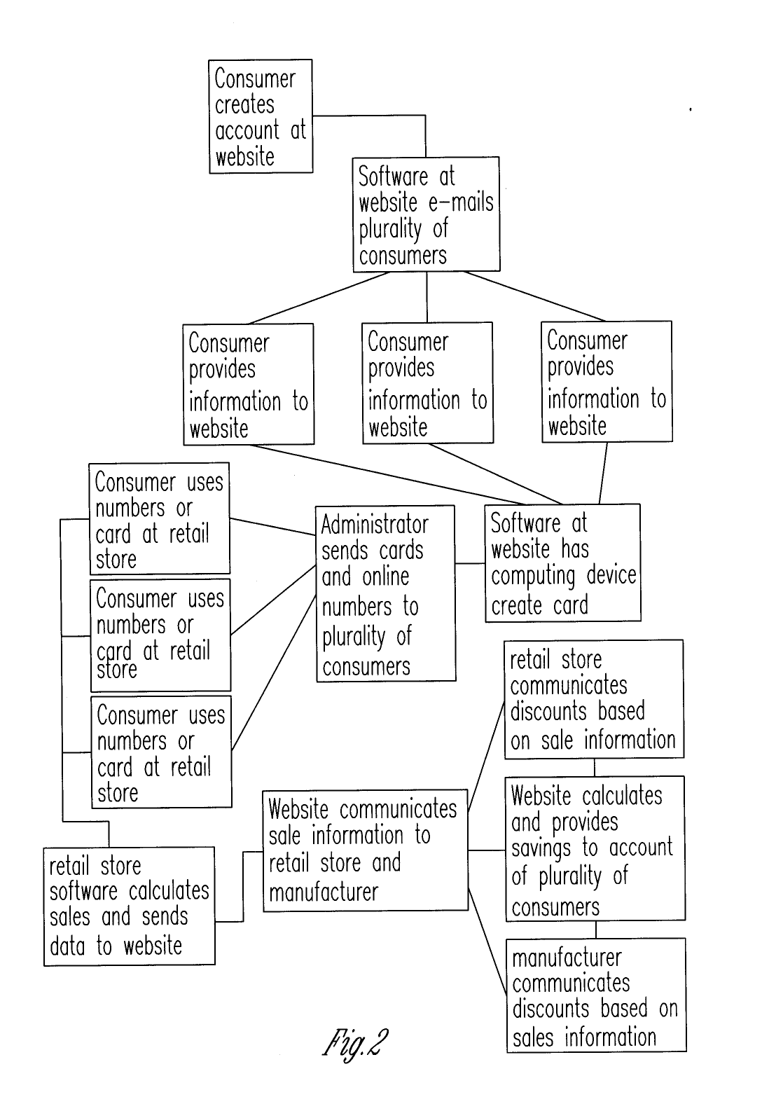

FIG. 3 is a flow diagram of a method of providing savings.

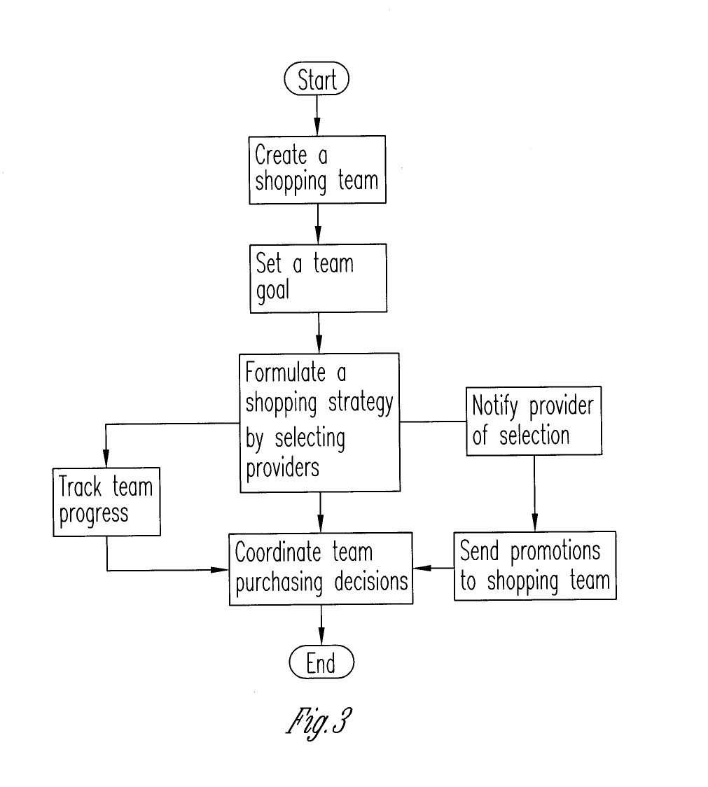

### DETAILED DESCRIPTION OF THE PREFERRED EMBODIMENT

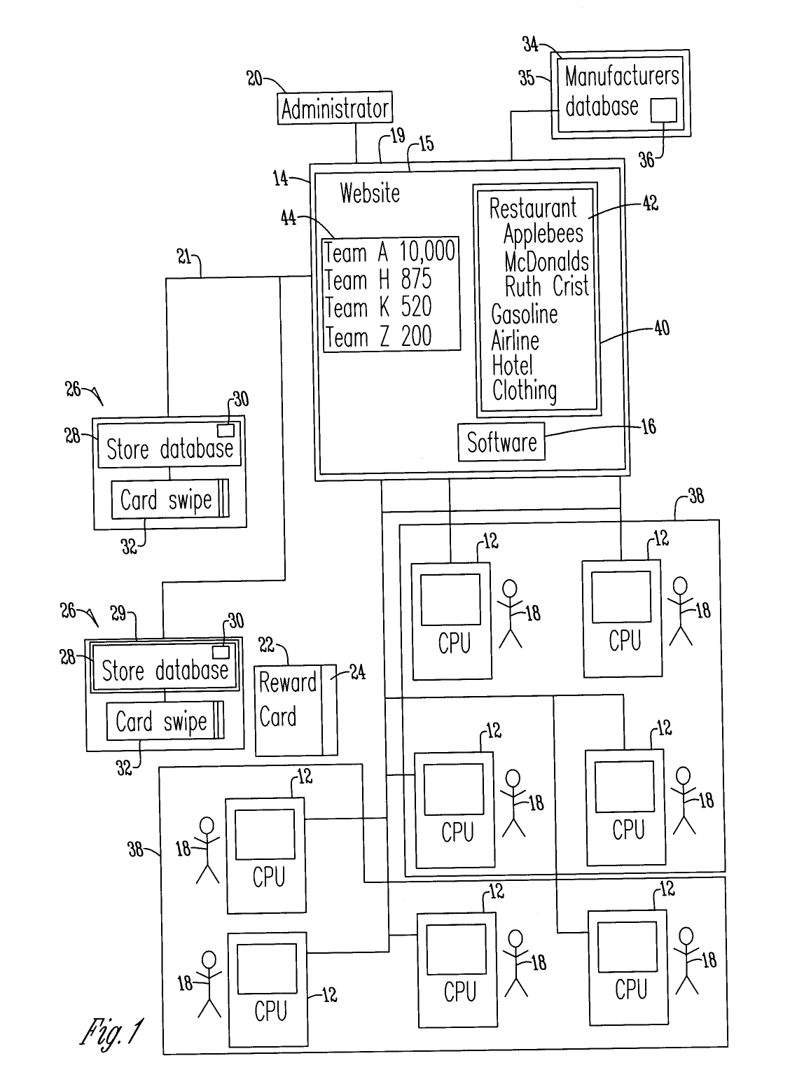

FIG. 1 shows a shopping system 10 that includes a computing device 12 that can access a website 14 on a server 15 via the internet. The website 14 has associated software 16 capable of creating accounts for a plurality of consumers 18. The computing device 12 can be any type of computing device including but not limited to a personal computer, a laptop computer, a blackberry, a cellular or mobile telephone, an iPad, any other handheld electrical device that can access the internet, and the like. The website 14 meanwhile is maintained using a computing device 19 that is operated by an administrator 20 that similarly accesses and maintains the website 14 over an electronic network 21 associated with the server 15 and computing devices 12 and 19. Thus, the administrator 20 can update the software 16 or correct mistakes in the software 16 as is desired.

The administrator 20 issues each of the plurality of consumers 18 a card 22 with identifying indicia 24 thereon such as a magnetic strip, bar codes, RF tag, or the like. The identifying indicia 24 contains purchasing information thereon that is specific to the individual consumer possessing the card 22.

Also included in the system 10 are a plurality of product or service providers 26 wherein each provider 26 includes a provider database 28 on a provider computing device 29 such as a personal computer, laptop, or any other such device that can hold information regarding consumers and the items that they purchase. The product or service provider can include, retail stores, on-line retail websites, hotels, airlines, car rental providers, and the like. The provider database 28 has software 30 therein that is in electrical communication with the software 16 at the website 14 via the server 15. In this manner an electrical reading device 32 such as a card swiper may be electrically connected to the provider database 28 and software 30 such that when one of the plurality of consumers 18 swipes their card 22 the identifying indicia 24 is read by the electrical reading device 32 so that personal customer information about the individual customer is relayed to and from the software 30 of the provider database 28 to the software 16 of the website 14.

The system similarly includes a manufacturer's database 34 on a computing device 35 of the manufacturer that includes software 36 that communicates with the software 16 at the website 14 via the server 15. Thus, at the database 34 of the manufacturer the software 36 calculates and computes when and how much of particular products are being purchased by the plurality of consumers 18.

In operation, a plurality of consumers 18 that know one another socially either by being friends, in groups together, family members, or the like can decide to form a shopping team 38. One of these consumers then accesses the website 14 on the server 15 from a computing device 12 and opens or creates an account by inputting information into the software 16. At this time the software 16 prompts the consumer to input information regarding the plurality of consumers 18 including the amount of consumers that are on a team, individual information such as e-mail addresses of each of the plurality of consumers 18, types of stores that the plurality of consumers 18 or team shop and the types of products that the plurality of consumers 18 purchase.

Once the account is set up, e-mails are sent to the other members of the team to request additional personal information from each team member. Alternatively, team members on their own, without being prompted by the software 16, can access the website 14 and with a password or passcode can join the account. Once a consumer from the plurality of consumers 18 provides the personal information needed to access the account made by the software 16 the software 16 generates a card 22 with a computing device 19 and the administrator 20 issues the consumer the card 22 that pertains specifically to that consumer. Additionally, a team rewards number can optionally be provided for the team that assists in keeping track of purchases and points earned on-line.

At this time the plurality of consumers 18 begin shopping at their individual stores buying their individual products. As the plurality of consumers 18 purchase items at stores the software 16 at the website 14 keeps track of the items purchased and the stores the items are purchased from and calculates all the sales made by the entire group of the plurality of consumers 18. Specifically, as the team makes purchases they accumulate points. The product or service provider 26 and/or manufacturer can then optionally chose to provide free items or gifts as points are being accumulated. Similarly, team members may trade in their points for free items, gifts or even team trips. Specifically, the card 22 can have a travel identification number associated therewith that can be utilized when purchasing flights, hotels or rental cars in order to earn points and discounts. Alternatively promotions can be provided where the first ten teams earning a predetermined point level earn a trip to a destination such as Jamaica.

Then, once a predetermined sales number or points is reached either at the provider 26 or of a particular product of the manufacturer the website 14 communicates with the provider database 28 and/or with the manufacturer database 34 and a discount or savings is provided by the provider software 30 or the manufacturer software 36 and communicated to the website 14. The software 16 of the website 14 then calculates and provides that savings to the account so that each consumer of the plurality of consumers 18 receives the discount and savings as a result of the team reaching the predetermined limit or amount of points. This savings can be in the form of a rebate, a coupon applied to the account, a percent reduction of the price of a product, a percent reduction in the cost of a total bill, a free gift, free travel or the like. Further, savings can be applied equally among all of the team members or alternatively applied to correspond to the amount of purchases or money spent by each consumer at a particular provider 26 or of a particular product.

The plurality of consumers 18 can also directly contact each other through instant messaging via the software 16 at the website 14 so that consumers communicate with one another regarding the products and stores they buy. In addition, each of the plurality of consumers 18 can access the website 14 and log into their team's page in order to review statistical information provided by the software 16. Specifically, the software 16 provides statistical information regarding each member of the team in order to see the amount and dollar amount of purchases each individual is making and what products each individual is purchasing in order to help influence purchasing decisions. Specifically, if a team only needs to purchase one more of a certain product in order to reach the predetermined amount in the account to receive a discount, the team member is encouraged to go out and purchase that specific product to ensure they receive the discount. The shopping team 38 is designed to create and encourage a connected group of consumers 18 to work together as a team by setting team goals, formulating shopping strategies, and working together to achieve objectives while at the same time competing against other teams. The website 14 facilitates this team effort. For example, the website presents a screen 40 that includes a listing of product or service categories 42 such as restaurants, gas stations, airlines, hotels, clothing stores and the like. When formulating the shopping team 38, a consumer 18 is prompted to set a goal such as earning 10,000 reward points each month. Alternatively the administrator 20, product or service provider 26, or manufacturer 33 can post a shopping challenge that is accepted by a consumer 18 and/or shopping team 38. Once a goal is set, a consumer 18 or team 38 formulate a strategy for reaching the desired goal. This would be done by selecting specific product or service providers 26 from the product or service categories 42 presented on screen 40. Preferably the selection is based upon the teams 38 interests, shopping habits, and reward points offered by various product or service providers 26. For example under the category 42 clothing, the service provider Old Navy would be selected and under the category 42 restaurant, Applebee's would be selected. These selections would encourage the team to shop at these providers to more quickly attain the set goal.

When a team 38 selects specific providers 26, the providers 26 are notified by the administrator 20 over the electronic network 21. The notifications allow providers 26 to send promotions offering additional bonus points to the team 38 through the administrator 20. For example if a team 37 selects Target, then Target is notified of the selection and can send a promotion that if two cases of Gatorade are purchased within a week, the team can earn an additional 500 bonus points.

The website 14 also has software 16 that enables teams 38 to track the progress of the team 38 and each consumer 18 on the team. In this manner, team members can communicate with each other and work together to make decisions on who on the team will make purchases at specific providers to maximize points.

The website also has a screen 44 that lists the top teams overall, for specific challenges, and for specific categories. This enables teams to compete against other teams for bonus points and rewards. For example, the administrator or provider offers specific rewards or bonuses for the top ten teams at the end of the month.

The system is also designed to provide rewards to individual consumers 18 who are the top purchaser overall or on each teach 38.

Thus presented are a shopping system 10 and a method of providing savings using that system 10. The system 10 creates teams of individuals that shop as a team in order to achieve discounts. This provides a method of social networking and discussion to get a plurality of consumers 18 to shop at certain retail stores and to discuss products with one another. At the same time this provides savings to the team and enhances the shopping experience. Thus, at the very least all of the stated objectives have been met.

It will be appreciated by those skilled in the art that other various modifications could be made to the device without departing from the spirit and scope of this invention. All such modifications and changes fall within the scope of the claims and are intended to be covered thereby.

What is claimed is:

1. A method of providing savings steps comprising:
providing a website on a server accessible by a computing device of an administrator;
sending personal information with a computing device of a consumer to the website;
generating an account at the website having a plurality of consumers associated therewith;
electrically communicating via an electronic network purchasing information from the plurality of consumers associated with the account from a computing device having a database associated with a provider; and
calculating and providing savings in the account received by each of the plurality of consumers.

2. The method of claim 1 wherein the step of electrically communicating purchasing information comprises the steps of:
scanning a card with a scanning device that communicates account information of a consumer to the database of the computing device associated with the product or service provider; and
said computing device associated with a product or service provider having software that indentifies the account information and electrically communicates the purchasing information to the website.

3. The method of claim 1 further comprising the step of:
generating statistical information about the account at the website; and
providing the statistical information at the website.

4. The method of claim 3 wherein the statistical information includes the dollar amount each of the plurality of consumers has spent.

5. The method of claim 3 wherein the statistical information includes the dollar amount saved in the account.

6. The method of claim 3 wherein a consumer of the plurality of consumers uses a computing device to access the website and view the statistical information.

7. The method of claim 1 wherein the product or service provider is a retail store.

8. The method of claim 1 wherein the product or service provider is a hotel.

9. The method of claim 1 wherein the product or service provider is an airline.

10. The method of claim 1 wherein the product or service provider is a rental car service provider.

11. The method of claim 1 wherein the product or service provider is an on-line retail store.

12. A method of providing savings comprising the steps of:
providing a website on a server accessible by a computing device of an administrator;
creating a shopping team by sending personal information with a computing device of at least one consumer to the website;
setting a team shopping goal by selecting information displayed on the website;
formulating a shopping strategy by selecting providers from a screen on the website listing categories; and
coordinating purchasing decisions of the shopping team to earn reward points.

13. The method of claim 12 wherein the step of creating a team goal includes selecting a challenge posted on the website.

14. The method of claim 12 wherein the step of formulating a shopping strategy includes selecting categories based upon a consumer's interests, shopping habits, or reward points offered.

15. The method of claim 12 further comprising the step of notifying the provider of selection by a shopping team.

16. The method of claim 15 further comprising the step of sending a promotion from a selected provider to the shopping team.

17. The method of claim 12 further comprising the step of providing a screen on the website where the shopping team tracks progress toward the shopping goal.

18. The method of claim 12 further comprising the step of providing a screen on the website where the shopping team compares progress with other shopping teams.

19. The method of claim 18 wherein reward points are awarded to top teams.

20. The method of claim 12 wherein reward points are awarded to a consumer on the shopping team with the most points.
